(19) United States
(12) Patent Application Publication
(10) Pub. No.: US 2024/0113757 A1
(43) Pub. Date: Apr. 4, 2024

(54) METHOD AND APPARATUS FOR CSI PREDICTION IN WIRELESS NETWORKS

(71) Applicant: Sumsung Electronics Co., Ltd., Suwon-si (KR)

(72) Inventors: Ashwini KUMAR, Bangalore (IN); Ameha Tsegaye ABEBE, Suwon-si (KR); Ashok Kumar Reddy CHAVVA, Bangalore (IN); Sripada KADAMBAR, Bangalore (IN)

(21) Appl. No.: 18/475,714

(22) Filed: Sep. 27, 2023

Related U.S. Application Data
(63) Continuation of application No. PCT/KR23/14691, filed on Sep. 25, 2023.

(30) Foreign Application Priority Data
Sep. 26, 2022 (IN) 202241055533
Sep. 7, 2023 (IN) 202241055533

(51) Int. Cl. H04B 7/06

(52) U.S. Cl. CPC H04B 7/0626; H04B 7/063

(57) ABSTRACT

Embodiments herein provide a method for channel state information (CSI) prediction by a user equipment (UE) in a wireless network. The method comprises determining a CSI; inputting the determined CSI to at least one machine learning (ML) based CSI prediction model to obtain at least one predicted precoder; encoding the at least one predicted precoder into at least one bit stream using at least one ML based CSI encoding model or at least one non-ML based CSI encoding model; and transmitting the at least one encoded bit stream to a network apparatus in the wireless network for the ML based CSI prediction at the network apparatus.

### CROSS-REFERENCE TO RELATED APPLICATIONS

This application is a continuation of International Application No. PCT/KR2023/014691 designating the United States, filed on Sep. 25, 2023, in the Korean Intellectual Property Receiving Office and claiming priority to Indian Provisional Patent Application No. 202241055533 filed on Sep. 28, 2022, in the Indian Patent Office, and to Indian Complete Patent Application No. 202241055533, filed on Sep. 7, 2023, in the Indian Patent Office, the disclosures of each of which are incorporated by reference herein in their entireties.

### BACKGROUND

### Field

The disclosure relates to a method and an apparatus for channel state information (CSI) prediction in wireless communications and, for example, to machine learning based CSI prediction in wireless networks.

### Description of Related Art

The current methodologies employed by New Radio (NR) 5G technologies rely on a codebook-based approach, where a discretized representation of the true Channel State Information (CSI) is conveyed to the 3GPP base station. However, these existing methods encounter challenges stemming from either suboptimal precision of the reporting mechanism, often arising in attempts to enhance precision. This difficulty is further compounded by the shorter intervals at which CSI reports are dispatched, as set by the base station to restrict overall resource utilization for reporting purposes within the entire system.

In this context, there exists a pressing need for an innovative approach that circumvents the limitations of current techniques. Addressing these challenges with a novel method can lead to substantial improvements in the accuracy of reported CSI data without incurring a disproportionate increase in reporting overhead. Such an advancement would be particularly beneficial in scenarios where periodic CSI reporting intervals are intentionally minimized/reduced by the base station to mitigate the broader impact on system resources dedicated to reporting functions. By devising an efficient and effective solution, the drawbacks of current New Radio 5G technologies can be mitigated, resulting in an optimized and streamlined approach to CSI reporting.

What is needed is a method that addresses the shortcomings of existing approaches, thereby enhancing the precision of reported CSI while simultaneously minimizing/reducing the associated reporting overhead.

### SUMMARY

Embodiments of the disclosure provide a machine learning based CSI prediction in wireless networks.

Embodiments of the disclosure transmit an encoded bit stream to a network apparatus in the wireless network for the ML based CSI prediction at the network apparatus.

Embodiments of the disclosure decode the encoded bit stream to obtain the one predicted precoder using a ML based CSI compression model or a non-ML based CSI compression model.

Embodiments of the disclosure input the predicted precoder to the ML based CSI prediction model to obtain predicted CSI.

Embodiments of the disclosure provide a machine learning based CSI prediction in wireless networks.

An example embodiment of the disclosure provides a method for channel state information (CSI) prediction in a wireless network. The method may comprise determining a CSI. The method may comprise inputting the determined CSI to a machine learning (ML) based CSI prediction model to obtain a predicted precoder. The method may comprise encoding the predicted precoder into a bit stream using a ML based CSI encoding model or a non-ML based CSI encoding model. The method may comprise transmitting the encoded bit stream to a network apparatus in the wireless network for the ML based CSI prediction at the network apparatus.

Inputting the determined CSI to at least one ML based CSI prediction model to obtain at least one predicted precoder may comprise determining at least one of a UE side precoder vector and a network apparatus side precoder vector based on the CSI. Inputting the determined CSI to at least one ML based CSI prediction model to obtain at least one predicted precoder may comprise inputting the UE side precoder vector and the network apparatus side precoder vector to the ML based CSI prediction model to obtain the at least one predicted precoder.

Inputting the determined CSI to at least one ML based CSI prediction model to obtain at least one predicted precoder may comprise inputting the CSI to the ML based CSI prediction model to obtain a predicted CSI. Inputting the determined CSI to at least one ML based CSI prediction model to obtain at least one predicted precoder may comprise determining at least one of a UE side precoder vector and a network apparatus side precoder vector based on the predicted CSI.

Inputting the determined CSI to at least one ML based CSI prediction model to obtain at least one predicted precoder may comprise determining at least one of a UE side precoder vector and a network apparatus side precoder vector based on the CSI. Inputting the determined CSI to at least one ML based CSI prediction model to obtain at least one predicted precoder may comprise determining at least one candidate CSI to be reported for each channel rank indicator of a plurality of channel rank indicators based on the UE side precoder vector and the network apparatus side precoder vector. Inputting the determined CSI to at least one ML based CSI prediction model to obtain at least one predicted precoder may comprise determining at least one predicted rank CSI based on the at least one candidate CSI to be reported for each channel rank indicator of the plurality of channel rank indicators using the at least one ML based CSI prediction model. Inputting the determined CSI to at least one ML based CSI prediction model to obtain at least one predicted precoder may comprise determining the at least one predicted precoder for each channel rank indicator of the plurality of channel rank indicators based on the at least one predicted CSI.

The at least one non-ML based CSI encoding may comprise at least one of quantization of the at least one predicted precoder, a New Radio (NR) precoding Type I codebook, and a NR precoding Type II codebook and compressive sensing.

The at least one encoded bit stream may be transmitted to the network apparatus using a specified CSI reporting air interface.

The method may comprise selecting an artificial intelligence model from a set of pre-trained encoders and decoders stored in a memory of the UE based on an AI model indicator received from the network apparatus for the ML based CSI encoding.

An example embodiment of the disclosure provides a method for channel state information (CSI) prediction by a network apparatus in a wireless network. The method may comprise receiving at least one encoded bit stream from a UE in the wireless network. The method may comprise decoding the at least one encoded bit stream to obtain at least one predicted precoder using at least one machine learning (ML) based CSI compression model or at least one non-ML based CSI compression model. The method may comprise inputting the at least one predicted precoder to the ML based CSI prediction model to obtain predicted CSI.

Inputting the at least one decoded precoder to obtain the predicted CSI may comprise determining at least one of a UE side precoder vector and a network apparatus side precoder vector based on the at least one predicted precoder. Inputting the at least one decoded precoder to obtain the predicted CSI may comprise inputting at least one of the UE side precoder vector and the network apparatus side precoder vector to the ML based CSI prediction model to obtain the predicted CSI.

Inputting the at least one decoded precoder to obtain the predicted CSI may comprise determining at least one of a UE side precoder vector and a network apparatus side precoder vector based on the at least one predicted precoder. Inputting the at least one decoded precoder to obtain the predicted CSI may comprise determining at least one candidate CSI for each channel rank indicator of a plurality of channel rank indicators based on the at least one of the UE side precoder vector and the network apparatus side precoder vector. Inputting the at least one decoded precoder to obtain the predicted CSI may comprise inputting at least one candidate CSI to the ML based CSI prediction model to obtain the predicted CSI.

The at least one non-ML based CSI encoding model may comprise at least one of quantization of the at least one predicted precoder, a New Radio (NR) precoding Type I codebook, and a NR precoding Type II codebook and compressive sensing.

The at least one encoded bit stream may be received from the UE using a specified CSI reporting air interface.

The method may comprise selecting an artificial intelligence model from a memory of the network apparatus based on an artificial intelligence, AI, model indicator for the ML based CSI encoding.

The method may comprise selecting at least one AI model from a set of trained encoders and decoders stored in the memory of the network apparatus. The method may comprise transferring at least one AI encoder model to the UE and indicating to select at least one AI model based on the AI model indicator.

The UE may download the at least one AI encoder model from the network apparatus and configure the at least one AI encoder model for CSI encoding based on the AI model indicator.

According to an example embodiment a user equipment (UE) for channel state information, CSI, prediction in a wireless network is provided. The UE may comprise a memory and at least one processor coupled to the memory. The at least one processor may be configured to determine a CSI. The at least one processor may be configured to input the determined CSI to a machine learning (ML) based CSI prediction model to obtain a predicted precoder. The at least one processor may be configured to encode the predicted precoder into a bit stream using a ML based CSI encoding model or a non-ML based CSI encoding model. The at least one processor may be configured to transmit the encoded bit stream to a network apparatus in the wireless network for the ML based CSI prediction at the network apparatus.

According to an example embodiment a network apparatus for channel state information, CSI, prediction in a wireless network is provided. The network apparatus may comprise a memory and at least one processor coupled to the memory. The at least one processor may be configured to receive at least one encoded bit stream from a UE in the wireless network. The at least one processor may be configured to decode the at least one encoded bit stream to obtain at least one predicted precoder using at least one machine learning (ML) based CSI compression model or at least one non-ML based CSI compression model. The at least one processor may be configured to input the at least one predicted precoder to the ML based CSI prediction model to obtain predicted CSI.

These and other aspects of the various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure, and the embodiments herein include all such modifications.

### BRIEF DESCRIPTION OF THE DRAWINGS

The embodiments disclosed herein are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1A is a signal flow diagram illustrating a procedure of conventional CSI reporting used by the network apparatus, according to the prior art;

FIG. 1B is a signal flow diagram illustrating an example procedure of the channel state information (CSI) operation, according to various embodiments;

FIG. 1C is a signal flow diagram illustrating an example procedure of a new radio (NR) CSI operation, according to various embodiments;

FIG. 1D is signal flow diagram illustrating an example CSI reporting operation timeline, according to various embodiments;

FIG. 2 is a block diagram illustrating an example configuration of a system for ML based CSI prediction in a wireless network, according to various embodiments;

FIG. 3 is a diagram illustrating an example procedure of MIMO precoder generation, according to various embodiments;

FIG. 4 is a diagram illustrating an example procedure of the radio precoder selection for codebook based approach, according to various embodiments;

FIG. 5 is a signal flow diagram illustrating an example procedure of prediction based CSI reporting, according to various embodiments;

FIG. 6 is a signal flow diagram illustrating an example procedure of prediction based CSI reporting with ML CSI encoding model selection based, according to various embodiments;

FIG. 7 is a signal flow diagram illustrating an example procedure of prediction based CSI reporting with ML CSI encoding model transfer based, according to various embodiments;

FIGS. 8A and 8B are block diagrams illustrating example configurations of Machine Learning (ML) based CSI prediction operation jointly with CSI ML based encoding, according to various embodiments;

FIGS. 9A and 9B are block diagrams illustrating example configurations of usage of prediction with existing CSI encoding/decoding approach, according to various embodiments;

FIG. 10 is a diagram illustrating an example procedure of ML based CSI prediction of UE side precoder prediction, according to various embodiments;

FIG. 11 is a diagram illustrating an example procedure of ML based CSI prediction of UE side channel prediction, according to various embodiments;

FIG. 12 is a diagram illustrating an example procedure of ML based CSI prediction at UE side rank-i channel prediction, according to various embodiments;

FIG. 13 is a diagram illustrating an example procedure of ML based CSI prediction at network apparatus side precoder prediction, according to various embodiments;

FIG. 14 is a diagram illustrating an example procedure of ML based CSI prediction at network apparatus side rank-i channel prediction, according to various embodiments;

FIG. 15 is a diagram illustrating an example procedure of ML based CSI prediction at UE side precoder based prediction with conventional encoding, according to various embodiments;

FIG. 16 is a diagram illustrating an example procedure of ML based CSI prediction at UE side channel prediction, according to various embodiments;

FIG. 17 is a diagram illustrating an example procedure of ML based CSI prediction at UE side rank-i channel prediction, according to various embodiments;

FIG. 18 is a diagram illustrating an example procedure of ML based CSI prediction at network apparatus side precoder prediction, according to various embodiments;

FIG. 19 is a diagram illustrating an example procedure of ML based CSI prediction at network apparatus side rank-i channel prediction, according to various embodiments;

FIG. 20 is a block diagram illustrating an example of the UE side prediction operation in precoder domain, according to various embodiments;

FIG. 21 is a block diagram illustrating an example of the UE side prediction operation with ML based CSI compression, according to various embodiments;

FIG. 22 is a block diagram illustrating an example of the UE side prediction operation with ML based CSI compression, according to various embodiments;

FIG. 23 is a diagram illustrating example test equipment to detect the presence of the CSI prediction during reporting, according to various embodiments;

FIG. 24 is a flowchart illustrating an example method for Machine Learning (ML) based channel state information (CSI) prediction in a wireless network, according to various embodiments; and

FIG. 25 is a flowchart illustrating an example method for Machine Learning (ML) based channel state information (CSI) prediction in a wireless network, according to various embodiments.

### DETAILED DESCRIPTION

The various example embodiments herein and the various features and advantageous details thereof are explained more fully with reference to the non-limiting example embodiments that are illustrated in the accompanying drawings and described in the following disclosure. Descriptions of well-known components and processing techniques may be omitted so as to not unnecessarily obscure the embodiments herein. The various example embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the disclosure. Accordingly, the examples should not be construed as limiting the scope of the disclosure herein.

Embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be understood to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Some of the abbreviations used in the description may refer, for example, to the following:
MIMO—Multiple Input Multiple Output
CSI—Channel State Information
SVD—Singular value decomposition
SU-MIMO—Single-user MIMO
MU-MIMO—Multi-user MIMO
PMI—Precoding matrix indicator
RI—Rank indicator
CQI—Channel quality indicator
CNN—Convolutional neural networks
LSTM—Long-Short term memory neural networks
Bi-LSTM—Bi Long-Short terms memory neural networks
gNB—Next generation Node-B
BS—Base station
UE—User equipment
ML—Machine learning
AI—Artificial intelligence

Accordingly, the embodiments herein provide a machine learning based CSI prediction in wireless networks.

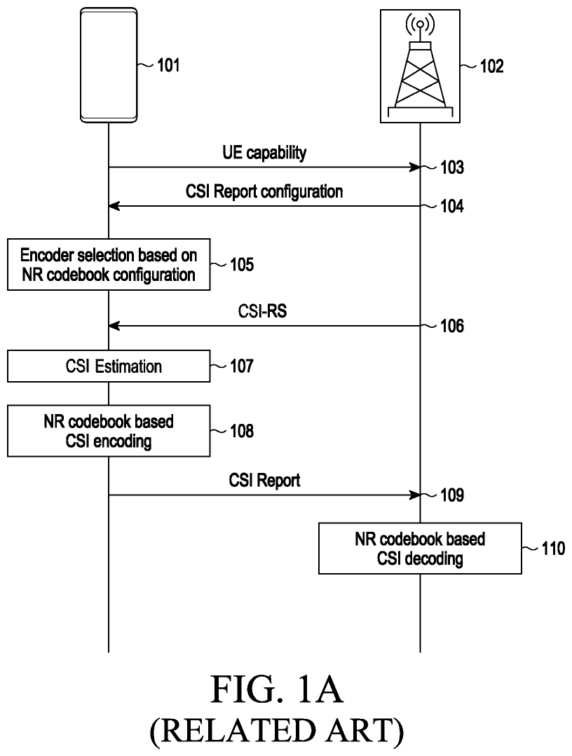

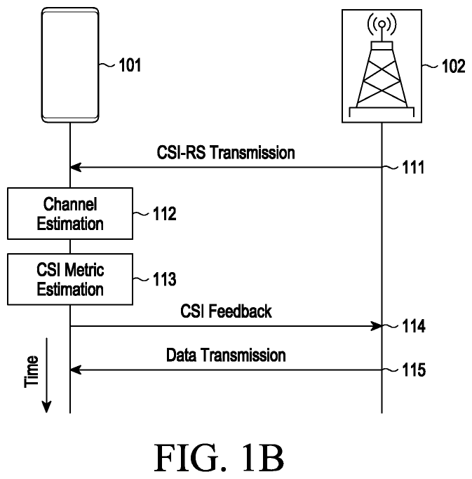

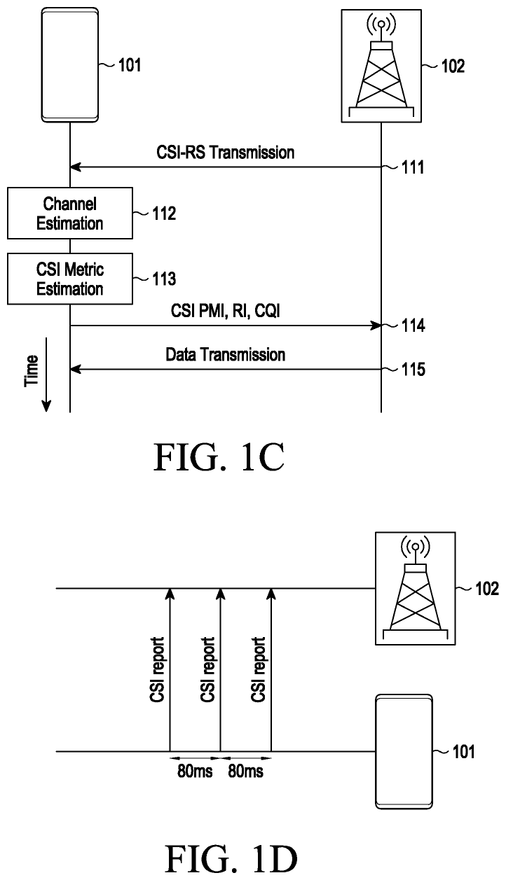

FIG. 1A is a signal flow diagram illustrating a procedure of conventional CSI reporting used by the new radio (NR), according to the prior art.

Referring to FIG. 1A considering the conventional methods, shows the conventional CSI reporting used by the new radio. FIG. 1A includes a UE (101), a network apparatus (102).

At step 103, determining the UE capability by the network apparatus (102); At step 104, specifying the CSI reporting configuration with the UE (101) by the network apparatus (102); selecting decoder by the network apparatus (102) based on the NR codebook configuration; at step 105, selecting encoder by the UE (101) based on the new radio codebook configuration; at step 106, sending CSI-RS to the UE (101) from the network apparatus (102); at step 107, estimating the CSI by the UE (101); at step 108, encoding CSI based on NR codebook; at step 109, sending CSI report to the network apparatus (102) from the UE (101); at step 110, decoding the CSI report based on the NR codebook.

FIG. 1B is a signal flow diagram illustrating an example procedure of the Channel State Information (CSI) operation, according to various embodiments.

Referring to FIG. 1B considering the disclosed method, CSI may refer, for example, to the set of indicators which provide information regarding the receiver channel state information to the network apparatus. FIG. 1B includes the UE (101), and the network apparatus (102).

In MIMO systems, availability of CSI is critical, as it allows the network apparatus (102) to perform operations such as beam forming, transmit rate adaptation etc., during single-user or multi-user MIMO operations. The UE (101) may be represented as a receiver in the following description. The network apparatus (102) may be represented as a Transmitter (gNB), and/or a base station (BS) in the following description. FIG. 1B shows the typical CSI operation workflow as follows: network apparatus (102) triggers the CSI reference signal (RS) transmission (111). Using the RS (111), the UE (101) may estimate the CSI (112). The UE (101) may estimate CSI metric (113). The CSI feedback (114) is then shared with the network apparatus (102). The network apparatus (102) then schedules the data transmission (115) using the CSI. The procedure is typically repeated at periodic intervals to update the CSI. The CSI is critical to MIMO operations. This is estimated at the receiver (101) and then shared with the network apparatus (102). Based on the received CSI, the network apparatus (102) decides the data transmission configuration.

FIG. 1C is a signal flow diagram illustrating an example procedure of a new radio (NR) CSI operation, according to various embodiments.

FIG. 1C, considering the disclosed method, illustrates an example CSI operation for 5G NR CSI feedback. FIG. 1C includes the UE (101) and the network apparatus (102).

The network apparatus (gNB) (102) triggers the CSI reference signal (RS) transmission (111). Using the RS (111), the UE (101) may estimate the CSI (112). The UE (101) may estimate CSI metric (113). The CSI parameters (114) are then shared with the network apparatus (102). The three CSI parameters of interest may include PMI (Precoding matrix indicator for MIMO precoder selection), RI (Rank indicator for transmission rank indication), and CQI (Channel Quality Indicator for data rate indication). The network apparatus (102) then schedules the data transmission (115) using the CSI parameters.

FIG. 1D is a signal flow diagram illustrating an example CSI reporting operation timeline, according to various embodiments.

FIG. 1D shows the operation timeline, according to various embodiments. The UE (101) shares CSI reports with the three parameters with the network apparatus (102) at periodic intervals determined by the network apparatus (102).

A New Radio (NR) and 3GPP system defines multiple CSI metrics. The disclosed method focuses on optimizing precoder reporting. Currently in the NR, it is handled by selecting a precoder from the codebook that is closest to the actual precoder.

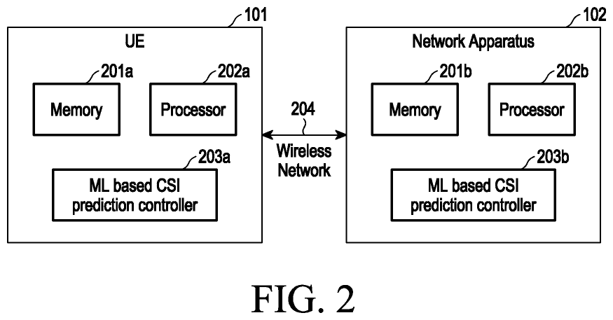

FIG. 2 is a block diagram illustrating an example configuration of a system for ML based CSI prediction in wireless networks, according to various embodiments. FIG. 2 includes the UE (101), the network apparatus (102) a wireless network (116). The UE (101) includes a memory (201a), a processor (e.g., including processing circuitry (202a), and a ML based CSI prediction controller (e.g., including various processing/control circuitry) (202a). The processor (202a) and ML based CSI prediction controller (203a) may be integrally referred to as at least one processor. The network apparatus includes a memory (201b), a processor (e.g., including processing circuitry) (202b), and a ML based CSI prediction controller (e.g., including various processing/control circuitry) (203b). The processor (202b) and ML based CSI prediction controller (203b) may be integrally referred to as at least one processor.

In an embodiment, the UE (101) for ML based CSI prediction in the wireless network (204) includes the memory (201a), the processor (202a); and the ML based CSI prediction controller (203a). The ML based CSI prediction controller (203a) communicatively coupled to the memory (201a) and the processor (202a).

The memory (201a) stores instructions to be executed by the processor (202a). The memory (201a) may include non-volatile storage elements. Examples of such nonvolatile storage elements include magnetic hard discs, optical discs, floppy discs, flash memories, or forms of Electrically Programmable Memories (EPROM) or Electrically Erasable and Programmable Memories (EEPROM). In addition, the memory (201a) in some examples, be considered a nontransitory storage medium. The term “nontransitory” indicates that the storage medium is not embodied in a carrier wave or a propagated signal. The term “non-transitory” is not be interpreted that the memory (201a) is nonmovable. In some examples, the memory (201a) stores larger amounts of information. In certain examples, a non-transitory storage medium stores data that can, over time, change (e.g., in Random Access Memory (RAM) or cache). The processor (202a) may include various processing circuitry, including, for example, one or a plurality of processors. The term “processor” or “controller”, as used herein may include various processing circuitry, including at least one processor, wherein one or more processors of the at least one processor may be configured to perform the various functions described herein.

The one or more processors may include a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). The processor (202a) includes multiple cores and executes the instructions stored in the memory (201a).

The UE (101) determines a channel state information (CSI) and input the CSI to a ML based CSI prediction model to obtain a predicted precoder. The UE (101) encodes the predicted precoder into a bit stream using the ML based CSI encoding model or the non-ML based CSI encoding model. The UE (101) transmits the encoded bit stream to the network apparatus (102) in the wireless network (204) for the ML based CSI prediction at the network apparatus (102).

In an embodiment, the network apparatus (102) for ML based CSI prediction in the wireless network (204) includes the memory (201b), the processor (202b), and the ML based CSI prediction controller (203b). The ML based CSI prediction controller (203b), communicatively coupled to the memory (201b) and the processor (202b) receives encoded bit stream from the UE (101) in the wireless network (204).

The memory (201b) stores instructions to be executed by the processor (202b). The memory (201b) includes non-volatile storage elements. Examples of such nonvolatile storage elements in cludes magnetic hard discs, optical discs, floppy discs, flash memories, or f orms of Electrically Programmable Memories (EPROM) or Electrically Era sable and Programmable Memories (EEPROM). In addition, the memory (2 01b) in some examples, be considered a nontransitory storage medium. The term “nontransitory” indicates that the storage medium is not embodied in a carrier wave or a propagated signal. The term “nontransitory” is not be interpreted that the memory (201b) is nonmovable. In some examples, the memory (201b) stores larger amounts of information. In certain examples, a nontransitory storage medium stores data that can, over time, change (e.g., in Random Access Memory (RAM) or cache). The processor (202b) includes one or a plurality of processors. The term “processor” or “controller”, as used herein may include various processing circuitry, including at least one processor, wherein one or more processors of the at least one processor may be configured to perform the various functions described herein.

The one or more processors may include a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). The processor (202b) includes multiple cores and is executes the instructions stored in the memory (201b).

The network apparatus (102) decodes the encoded bit stream to obtain the predicted precoder using the ML based CSI compression model or non-ML based CSI compression model. The network apparatus (102) inputs the predicted precoder to the ML based CSI prediction model to obtain predicted CSI.

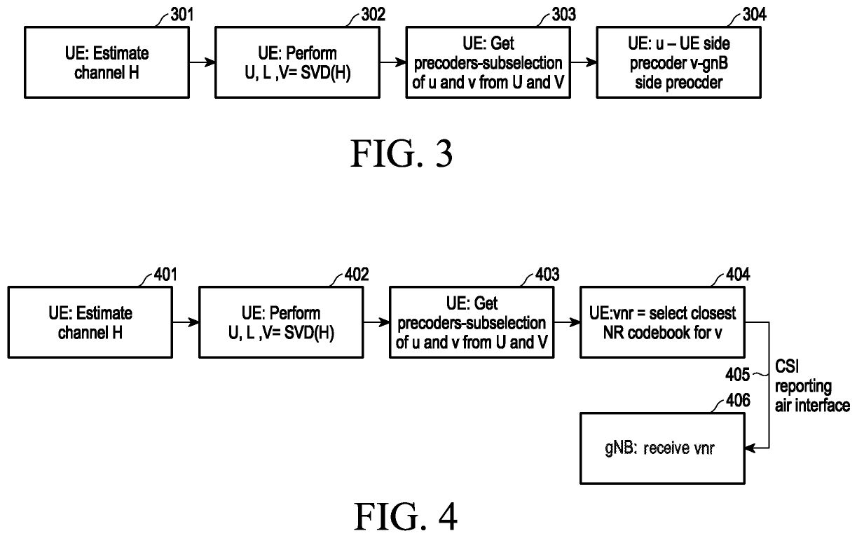

FIG. 3 is a diagram illustrating an example procedure of MIMO precoder generation, according to various embodiments.

FIG. 3, considering the disclosed method, summarizes the precoder computation for wireless systems. The precoder computation may be performed at the UE (101). At 301, the UE performs estimating the channel by the.

At 302, the UE (101) performs singular value decomposition (SVD) operation on the channel to obtain U—UE side Eigen vectors and V—the network apparatus side Eigen vectors.

At 303, a subset of the Eigen vectors are then selected as uεU—UE side precoders, vεV—the network apparatus side precoders in the remainder of the disclosed method, refer to both precoders u and/or v as p. The current NR CSI framework supports reporting of the network apparatus (102) side precoders v. The current NR CSI framework supports reporting of only the network apparatus (102) side precoders v to reduce the reporting feedback overhead, although it is beneficial to have ‘u’ in MU-MIMO.

At 304, the UE performs reporting both u and v precoders with reduced overhead.

FIG. 4 is a diagram illustrating an example procedure of the new radio precoder selection for codebook based approach, according to various embodiments.

FIG. 4, considering the disclosed method, summarizes the precoder selection and reporting scheme supported in the NR. The NR uses codebook based predictor selection. The codebook is a set of pre-defined precoders. Multiple codebook configurations are supported, for example:
Rel-15 Type-1
Rel-15 Type-2
Rel-16 Type-2

The type of codebook to be used is indicated by the network apparatus (102).

At 401, the precoder computation includes channel estimation.

At 402, the UE (101) performs singular value decomposition (SVD) operation on the channel to obtain: U—UE side Eigen vectors, V—network apparatus side Eigen vectors.

At 403, a subset of the Eigen vectors are selected as uεU—UE side precoders and vεV—network apparatus side precoders. For CSI reporting, the UE (101) computes the network apparatus (102) side precoder v.

At 404, the UE (101) selects its closest counterpart vnr from the codebook.

At 405, the UE (101) reports CSI to the network apparatus (102) over CSI reporting air interface.

At 406, the network apparatus (102) receive the vnr.

The precoders used in the new radio are codebook based. Due to this, they suffer from low accuracy, high reporting overhead, lack of support for reporting of the UE (101) side precoder which is useful for MU-MIMO operations, lack of support for channel prediction.

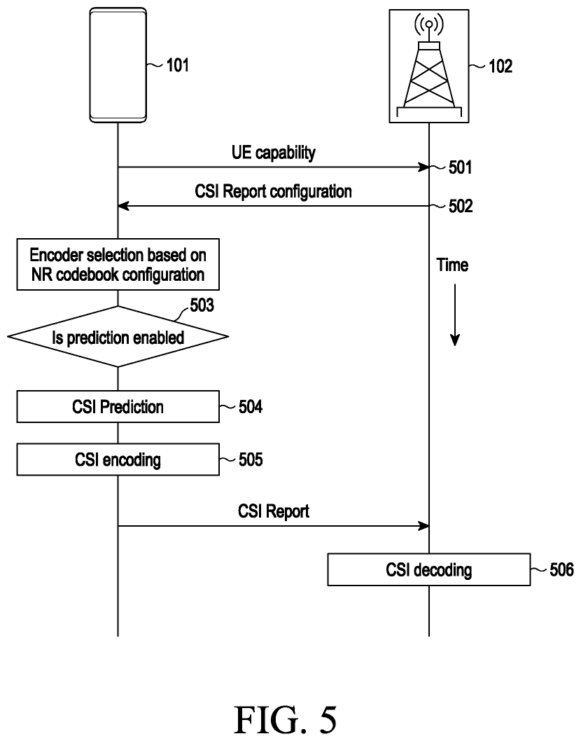

FIG. 5 is a diagram illustrating an example procedure of prediction based CSI reporting, according to various embodiments.

Unlike the conventional methods and systems, referring to FIG. 5, considering the disclosed method, the CSI reporting procedure using CSI prediction is depicted. Conventional codebook based CSI reporting is performed based on predicted CSI.

At 501, while CSI reporting, the UE (101) may include capability information on CSI prediction.

At 502, in CSI reporting configuration, the network apparatus (102) may specify the UE (101) on if CSI prediction should be enabled.

At 503, the UE may perform determining whether the prediction enabled. When enabled, the UE (101) may select a pre-trained prediction model to be used for CSI prediction.

At 504, the UE may perform CSI estimation/prediction, when prediction is enabled, the UE (101) may perform CSI prediction.

At 505, the UE may perform the CSI encoding.

At 506 reporting may be done done using traditional codebook based methods (Rel 15/16/17, Type-I/II) using the predicted CSI and decoding the CSI.

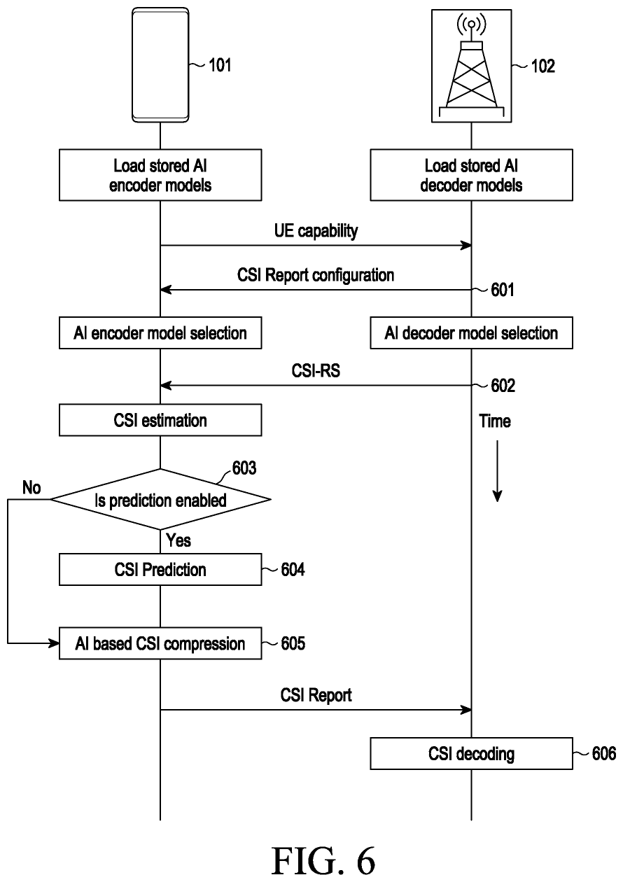

FIG. 6 is a diagram illustrating an example procedure of prediction based CSI reporting with ML CSI encoding model selection, according to various embodiments.

Unlike the conventional methods and systems, the disclosed CSI prediction method is used jointly with AI based CSI compression. In FIG. 6, AI model selection at the UE (101) and the network apparatus (102) is from a set of pre-trained encoders and decoders stored at the UE (101) and the network apparatus (102), respectively. The network apparatus (102) selects the model to be used and indicates it to the UE (101) via AI model indicator (AMI).

At 601, while CSI reporting, the UE (101) may include capability information on CSI prediction and AI based CSI compression.

At 602, in CSI reporting configuration, the network apparatus (102) may specify the UE (101) on if CSI prediction should be enabled. Also, AMI (AI model indicator) indicates the AI model configuration to be used for CSI encoding.

At 603, determining whether the CSI prediction is enabled. The UE (101) selects the AI model for CSI encoding based on AMI and the network apparatus (102) may select the corresponding AI model for CSI decoding.

At 604, based on CSI estimation, when prediction is enabled, the UE (101) may select a pre-trained prediction model to be used for CSI prediction; the UE (101) may perform CSI prediction.

At 605, the predicted CSI is encoded by the AI encoder model at the UE (101).

At 606, based on receiving this encoded CSI data, the network apparatus (102) reconstructs the predicted CSI data using the respective AI decoder model.

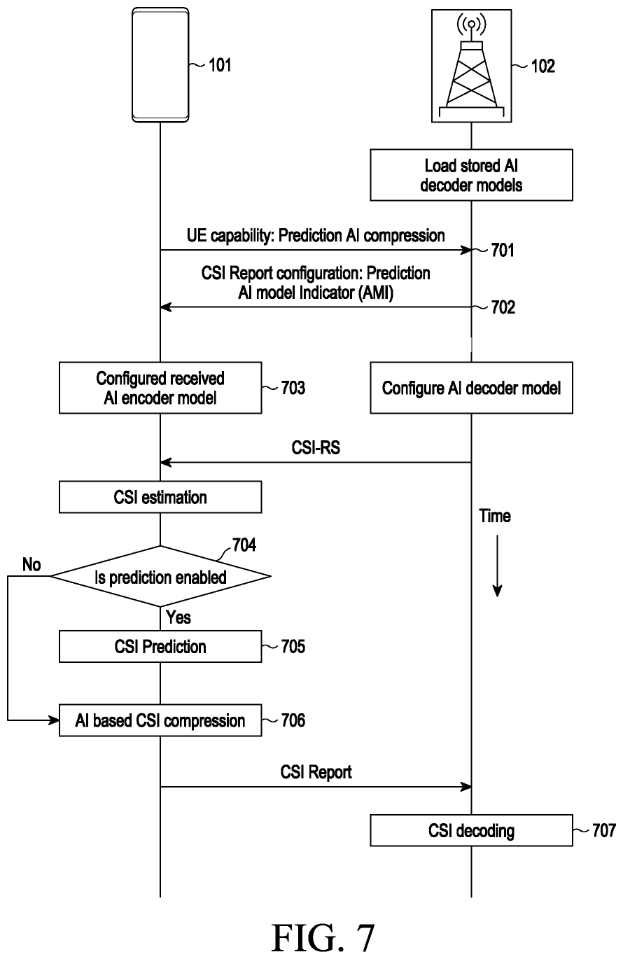

FIG. 7 is a diagram illustrating an example procedure of prediction based CSI reporting with ML CSI encoding model transfer based, according to various embodiments.

FIG. 7, considering the disclosed method, shows a CSI prediction method used jointly with AI based CSI compression. In FIG. 7, AI model selection at the network apparatus is from a set of pre-trained encoders and decoders stored in the network apparatus, respectively. For the selected AI model, the network apparatus (102) transfers the AI encoder model to the UE (101) and indicates the configuration using the AI model indicator (AMI). The UE (101) uses the downloaded model for CSI compression.

At 701, transmitting, UE capability (Prediction AI compression) to the network apparatus (102).

At 702, in CSI reporting configuration, the network apparatus (102) may specify the UE (101) on if CSI prediction should be enabled. Also, AMI indicates the AI model configuration to be used for CSI encoding.

At 703, the UE (101) downloads the AI encoder model from the network apparatus (102) and configures it for CSI encoding based on AMI. The network apparatus (102) may select the corresponding AI model for CSI decoding.

At 704, determining whether the prediction is enabled, the UE (101) select a pre-trained prediction model to be used for CSI prediction.

At 705, after CSI estimation, when prediction is enabled, the UE (101) perform CSI prediction.

At 706, the predicted CSI is encoded by the AI encoder model at the UE (101).

At 707, receiving this encoded CSI data by the network apparatus (102), the network apparatus (102) reconstructs the predicted CSI data using the respective AI decoder model.

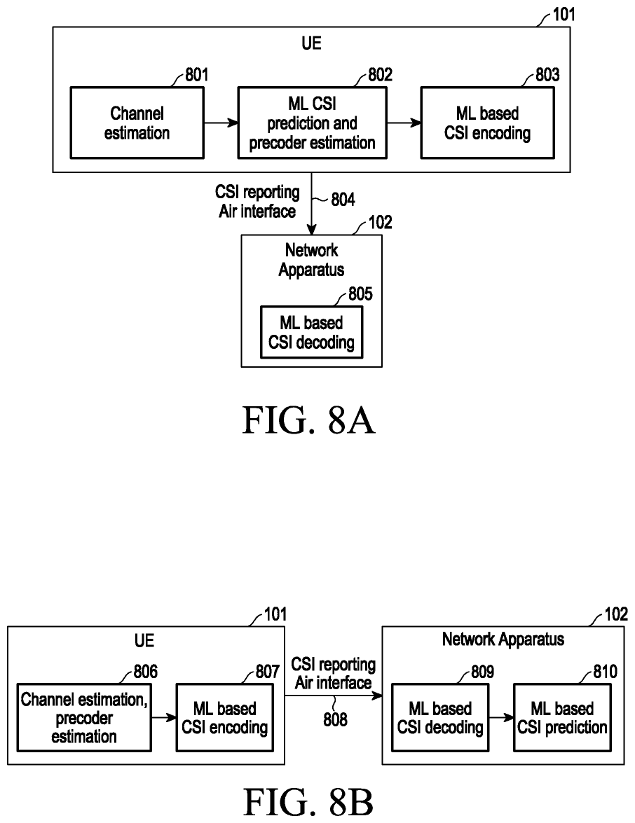

FIGS. 8A and 8B are block diagrams illustrating example configurations of Machine Learning (ML) based CSI prediction operation jointly with CSI ML based encoding, according to various embodiments.

FIG. 8A, considering the disclosed method, illustrates Machine learning based CSI prediction at the UE side followed ML based CSI encoding/decoding;

At 801, estimating the channel by the UE (101).

At 802, performing ML CSI prediction and precoder estimation by the UE (101).

At 803, performing ML based CSI encoding by the UE (101).

At 804, sending the CSI report to the network apparatus (102) over an CSI reporting air interface.

At 805, performing ML based CSI decoding by the network apparatus (102).

Referring to FIG. 8B, considering the disclosed method, illustrates Machine learning based CSI encoding/decoding followed by ML based CSI prediction at the network apparatus side.

At 806, performing channel estimation, precoder estimation by the UE (101).

At 807, performing ML based CSI encoding by the UE (101).

At 808, sending the CSI report to the network apparatus (102) over the CSI reporting air interface.

At 809, performing ML based CSI decoding by the network apparatus (102).

At 810, performing ML based CSI prediction by the network apparatus (102).

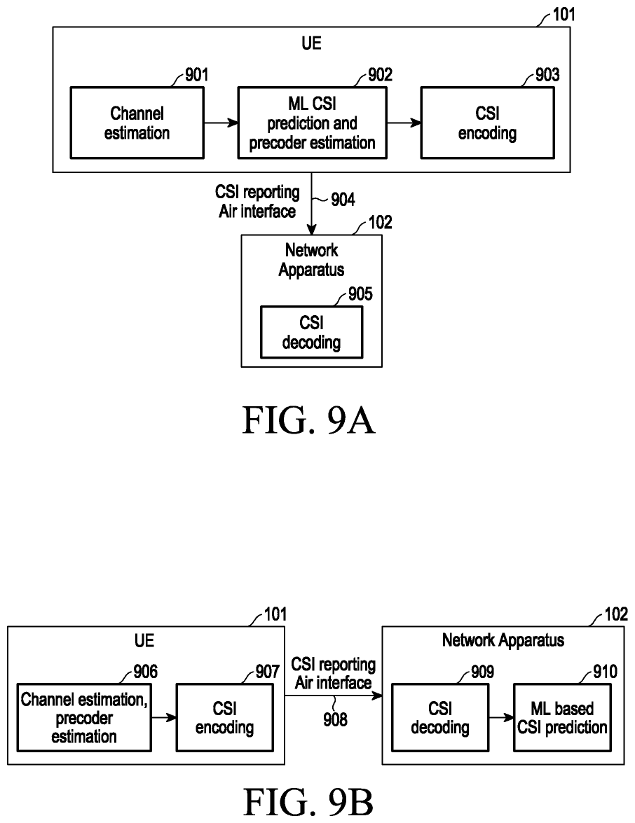

FIGS. 9A and 9B are diagrams illustrating examples of usage of prediction only approach to co-work with existing CSI encoding/decoding approach, according to various embodiments.

FIG. 9A, considering the disclosed method, the method provides a method of ML based CSI prediction at the UE followed by conventional CSI encoding/decoding.

At 901, estimating the channel by the UE (101).

At 902, performing ML CSI prediction and precoder estimation by the UE (101).

At 903, performing the CSI encoding by the UE (101).

At 904, transmitting the CSI report to the network apparatus (102) over the CSI reporting air interface.

At 905, performing the CSI decoding by the network apparatus (102).

Referring to FIG. 9B, considering the disclosed method, the method provides a method of CSI encoding/decoding followed by ML based CSI prediction at the network apparatus side.

At 906, performing the channel estimation, and precoder estimation by the UE (101).

At 907, performing the CSI encoding by the UE (101).

At 908, transmitting the CSI report to the network apparatus (102) over the CSI reporting air interface.

At 909, performing the CSI decoding by the network apparatus (102).

At 910, performing the ML based CSI prediction by the network apparatus (102).

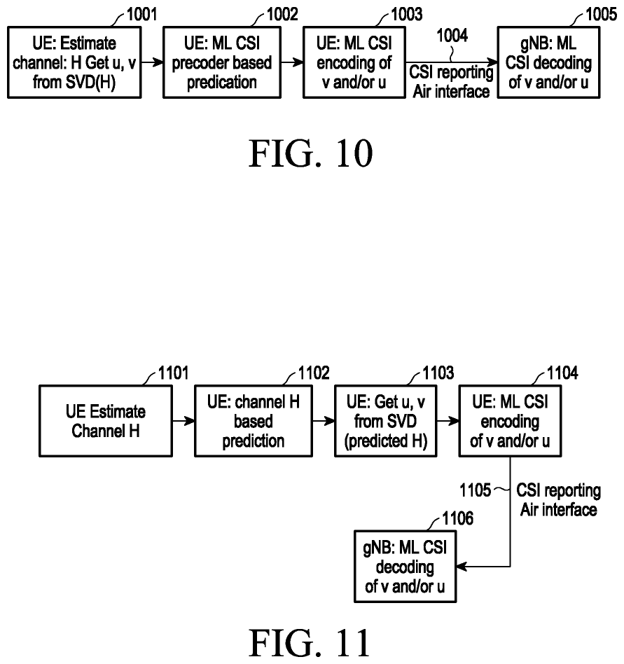

FIG. 10 is a diagram illustrating an example procedure of the ML based CSI prediction of UE side precoder prediction, according to various embodiments.

FIG. 10, considering the disclosed method, illustrates the ML based CSI prediction operation jointly with CSI ML based encoding.

The UE side precoder based prediction with ML based compression may be as follows:

At 1001, determining, by the UE (101) in the wireless network (204), a channel state information (CSI) (H); determining, by the UE (101), the UE (101) side precoder vector (u) and the network apparatus (102) side precoder vector (v) based on the CSI (h); determining, by the UE (101), candidate precoder (p) based on the UE (101) side precoder vector (u) and the network apparatus (102) side precoder vector (v).

At 1002, inputting, by the UE, the candidate precoder (p) to the ML based CSI prediction model to obtain the predicted precoder (U, V).

At 1003, encoding, by the UE (101), the predicted precoder into bit stream using ML based CSI encoding model or non-ML based CSI encoding model.

At 1004, transmitting, by the UE (101), the bit stream to the network apparatus (102) in the wireless network (204) through the CSI reporting air interface for the ML based CSI prediction.

At 1005, receiving, by the network apparatus (102), the encoded bit stream and decodes the precoders 5 using the ML based CSI decoder.

FIG. 11 is a diagram illustrating an example procedure of ML based CSI prediction of UE side channel prediction, according to various embodiments.

FIG. 11, considering the disclosed method, illustrates the UE side spatial channel H based prediction with ML based compression as follows:

At 1101, determining, by the UE (101) in the wireless network (204), a channel state information (CSI) (H).

At 1102, inputting, by the UE (101), the CSI (H) to the ML based CSI prediction model to obtain the predicted CSI (Hp).

At 1103, determining, by the UE (101), a UE side precoder vector (u) and the network apparatus side precoder vector (v) based on the predicted CSI (Hp); determining, by the UE (101), the candidate precoder (p) based on the UE side precoder vector (u) and the network apparatus side precoder vector (v).

At 1104; encoding, by the UE (101), the predicted precoder into bit stream using ML based CSI encoding model or non-ML based CSI encoding model.

At 1105, transmitting, by the UE (101), the encoded bit stream to the network apparatus (102) in the wireless network (204) through the CSI reporting air interface for the ML based CSI prediction.

At 1106, receiving, by the network apparatus (102), the bit stream and decodes the precoders \hat{p} using the ML based CSI decoder.

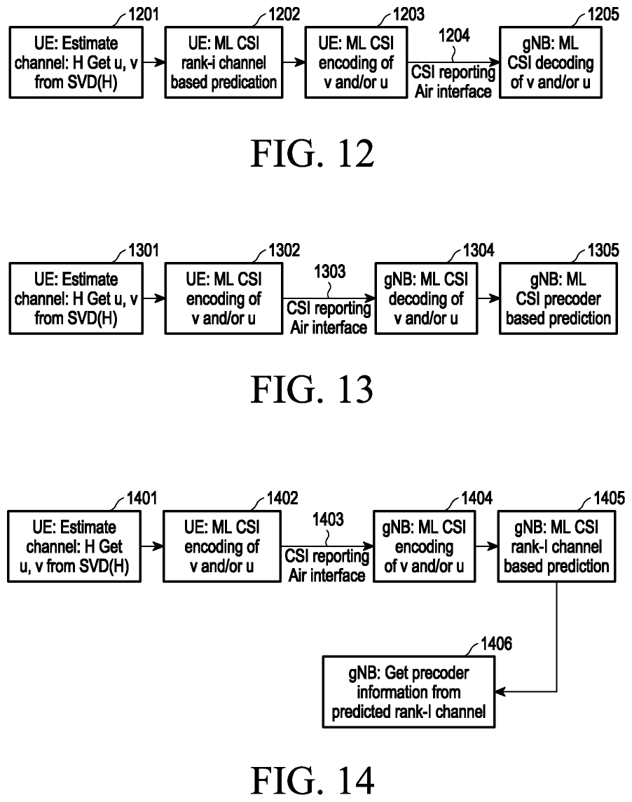

FIG. 12 is a diagram illustrating an example procedure of the ML based CSI prediction at UE side rank-i channel prediction, according to various embodiments.

FIG. 12, considering the disclosed method, illustrates the UE side rank-i channel based prediction with ML based compression, the steps may be as follows:

At 1201, determining, by the UE (101) in the wireless network (204), a channel state information (CSI) (H); determining, by the UE (101), the UE (101) side precoder vector (u) and the network apparatus (102) side precoder vector (v) based on the CSI (h); determining, by the UE (101), candidate precoder (p) based on the UE (101) side precoder vector (u) and the network apparatus (102) side precoder vector (v).

At 1202, determining, by the UE (101), candidate CSI (Hi) to be reported for each channel rank indicator of the channel rank indicators based on the candidate precoder (p); determining, by the UE (101), predicted rank CSI (Hₚⁱ) based on the candidate CSI (Hi) to be reported for each channel rank indicator of the channel rank indicators using the ML based CSI prediction model; determining, by the UE (101), the predicted precoder (U, V) for each channel rank indicator of the channel rank indicators based on the predicted CSI (Hₚⁱ).

At 1203, encoding, by the UE (101), the predicted precoder into bit stream using ML based CSI encoding model or non-ML based CSI encoding model.

At 1204, transmitting, by the UE (101), the encoded bit stream to the network apparatus (102) in the wireless network (204) through the CSI reporting air interface for the ML based CSI prediction.

At 1205, receiving, by the network apparatus (102), the bit stream and decodes the precoders \hat{p} using the ML based CSI decoder.

FIG. 13 is a diagram illustrating an example procedure of ML based CSI prediction, the network apparatus side precoder prediction, according to various embodiments.

FIG. 13, considering the disclosed method, illustrates the network apparatus side precoder prediction with ML based compression may be as follows:

At 1301, determining, by the UE (101) in the wireless network (204), a channel state information (CSI) (H); determining, by the UE (101), the UE (101) side precoder vector (u) and the network apparatus (102) side precoder vector (v) based on the CSI (H); determining, by the UE (101), candidate precoder (p) based on the UE (101) side precoder vector (u) and the network apparatus (102) side precoder vector (v).

At 1302, encoding, by the UE (101), the candidate precoder into a bit stream using ML based CSI encoding model.

At 1303, transmitting, by the UE (101), the encoded bit stream to the network apparatus (102) in the wireless network (204) through the CSI reporting air interface for the ML based CSI prediction.

At 1304, receiving, by the network apparatus (102), the encoded bit stream and decodes the precoders 5 using the ML based CSI decoder.

At 1305, determining, predicted precoder information for each rank precoders based on the latest L reconstructed precoders \hat{p} using the ML based CSI prediction.

FIG. 14 is a diagram illustrating an example procedure of ML based CSI prediction network apparatus side rank-i channel prediction, according to various embodiments.

FIG. 14, considering the disclosed method, illustrates the network apparatus side rank-i channel based prediction with ML based compression may be as follows:

At 1401, determining, by the UE (101) in the wireless network (204), a channel state information (CSI) (H); determining, by the UE (101), the UE (101) side precoder vector (u) and the network apparatus (102) side precoder vector (v) based on the CSI (H); determining, by the UE (101), candidate precoder (p) based on the UE (101) side precoder vector (u) and the network apparatus (102) side precoder vector (v).

At 1402, encoding, by the UE (101), the candidate precoder into bit stream using ML based CSI encoding model.

At 1403, transmitting, by the UE (101), the encoded bit stream to the network apparatus (102) in the wireless network (204) through the CSI reporting air interface for the ML based CSI prediction.

At 1404, receiving, by the network apparatus (102), the encoded bit stream and decodes the precoders \hat{p} using the ML based CSI decoder; reconstructing, by the network apparatus (102), rank-i channels for each reported rank information using the candidate precoder (p).

At 1405, determining, by the network apparatus (102), the UE side precoder vector (u) and the network apparatus side precoder vector (v) based on the candidate precoder; determining, by the network apparatus (102), candidate CSI (Hⁱ) for each channel rank indicator of the channel rank indicators based on the UE side precoder vector (u) and the network apparatus side precoder vector (v).

At 1406, inputting, by the network apparatus (102), candidate CSI (Hⁱ) to the ML based CSI prediction model to obtain the predicted CSI (Hₚⁱ) for each channel rank indicator which is then used to obtain the precoder information.

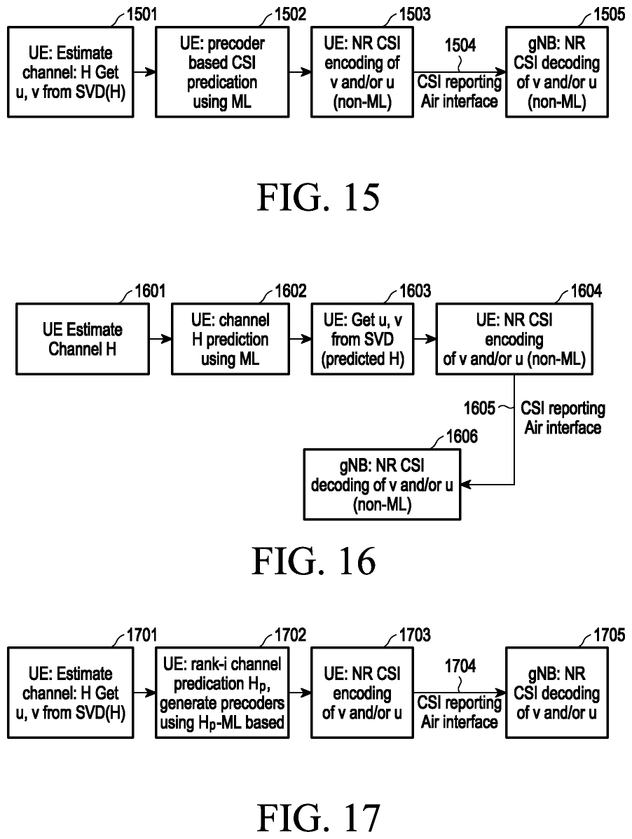

FIG. 15 is a diagram illustrating an example procedure of the ML based CSI prediction UE side precoder based prediction with conventional encoding, according to various embodiments.

FIG. 15, considering the disclosed method, illustrates the UE side precoder based prediction with conventional CSI encoding may be as follows:

At 1501, determining, by the UE (101) in the wireless network (204), the channel state information (CSI) (H); determining, by the UE (101), the UE (101) side precoder vector (u) and the network apparatus (102) side precoder vector (v) based on the CSI (h); determining, by the UE (101), candidate precoder (p) based on the UE (101) side precoder vector (u) and the network apparatus (102) side precoder vector (v).

At 1502, inputting, by the UE (101), the CSI (H) and the candidate precoder (p) to the ML based CSI prediction model to obtain the predicted precoder (U, V).

At 1503, encoding, by the UE (101), the predicted precoder into the bit stream using conventional CSI encoding; For example, quantization of the predicted precoders using NR Rel-15/16/17 type-1 or type-2 codebook.

At 1504, transmitting, by the UE (101), the encoded bit stream to the network apparatus (102) through the predefined CSI reporting air interface.

At 1505, receiving, by the network apparatus (102), the bit stream and decodes the precoder bit stream using predefined conventional approach; For example, when NR Rel-15/16/17 type-1/type-2 codebook is used, reconstruction is performed using the same codebook.

FIG. 16 is a diagram illustrating an example procedure of ML based CSI prediction UE side channel prediction, according to various embodiments.

FIG. 16, considering the disclosed method, illustrates the UE side spatial channel H based prediction with conventional encoding, may be follows:

At 1601, determining, by the UE (101) in the wireless network (204), a channel state information (CSI) (H).

At 1602, inputting, by the UE (101), the CSI (H) to the ML based CSI prediction model to obtain a predicted CSI (Hp).

At 1603, determining, by the UE (101), a UE side precoder vector (u) and a network apparatus side precoder vector (v) based on the predicted CSI (Hp).

At 1604, determining, by the UE (101), the predicted precoder based on a singular value decomposition of the predicted CSI (Hp); encoding, by the UE (101), the predicted precoder into bit stream using non-ML based CSI encoding model; the NR pre-coding codebooks such as Rel-15/16/17 of type-1 or type-2 are applicable.

At 1605, transmitting, by the UE (101), the encoded bit stream to the network apparatus (102) via a predefined CSI reporting air interface.

At 1606, receiving, by the network apparatus (102), the precoder bit stream (bp) and decodes the precoder p using ML based CSI decoder using the conventional CSI compression.

FIG. 17 is is a diagram illustrating an example procedure of ML based CSI prediction UE side rank-i channel prediction, according to various embodiments.

FIG. 17, considering the disclosed method, illustrates the UE side rank-i channel based prediction with conventional encoding, may be as follows:

At 1701, determining, by the UE (101) in the wireless network (204), a channel state information (CSI) (H); determining, by the UE (101), the UE side precoder vector (u) and the network apparatus side precoder vector (v) based on the CSI (H); determining, by the UE (101), candidate precoder (p) based on the UE side precoder vector (u) and the network apparatus side precoder vector (v).

At 1702, determining, by the UE (101), candidate CSI (Hi) to be reported for each channel rank indicator of the channel rank indicators based on the candidate precoder (p); determining, by the UE (101), predicted rank CSI (Hₚⁱ) based on the candidate CSI (Hi) to be reported for each channel rank indicator of the channel rank indicators using the ML based CSI prediction model; determining, by the UE (101), the predicted precoder (U, V) for each channel rank indicator of the channel rank indicators based on the predicted CSI (Hₚⁱ).

At 1703, encoding, by the UE (101), the predicted precoder into bit stream using conventional CSI encoding; Typical NR precoding mechanisms such as Rel 15/16/17 type-I or type-II codebook schemes are applicable.

At 1704, transmitting, by the UE (101), the encoded bit stream to the network apparatus (102) in the wireless network (204) through the CSI reporting air interface.

At 1705, receiving, by the network apparatus (102), the bit stream and decodes the precoders \hat{p} using the using the conventional CSI compression.

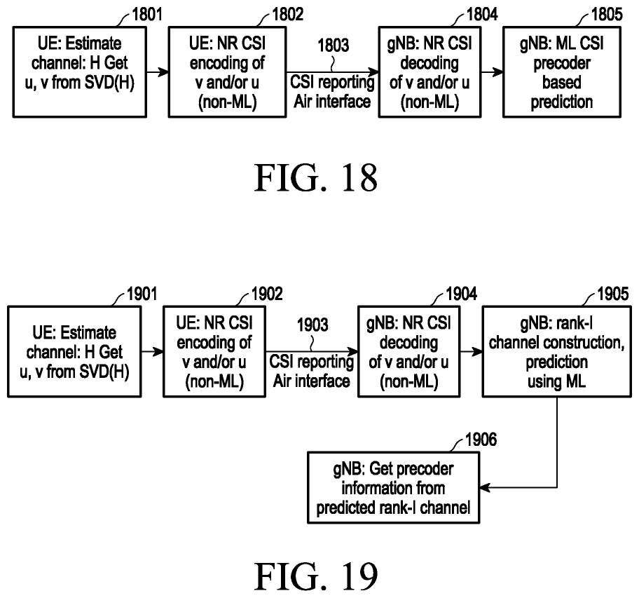

FIG. 18 is a diagram illustrating an example procedure of ML based CSI prediction network apparatus side precoder prediction, according to various embodiments.

FIG. 18, considering the disclosed method, illustrates the network apparatus side precoder based prediction with conventional CSI compression may be as follows:

At 1801, determining, by the UE (101) in the wireless network (204), a channel state information (CSI) (H); determining, by the UE (101), the UE (101) side precoder vector (u) and the network apparatus (102) side precoder vector (v) based on the CSI (H); determining, by the UE (101), candidate precoder (p) based on the UE (101) side precoder vector (u) and the network apparatus (102) side precoder vector (v).

At 1802, encoding, by the UE (101), the candidate precoder into bit stream using the conventional CSI encoding model; the new radio codebooks from Rel-16/17/18 of type-1 or type-2 are applicable.

At 1803, transmitting, by the UE (101), the encoded bit stream to the network apparatus (102) in the wireless network (204) through the CSI reporting air interface for the ML based CSI prediction.

At 1804, receiving, by the network apparatus (102), the encoded bit stream and decodes the precoders \hat{p} using the conventional CSI compression.

At 1805, determining, by the network apparatus (102), predicted precoder for each rank precoders based on the latest L reconstructed precoders \hat{p} using the ML based CSI prediction.

FIG. 19 is a diagram illustrating an example procedure of ML based CSI prediction network apparatus side rank-i channel prediction, according to various embodiments.

FIG. 19, considering the disclosed method, illustrates the network apparatus side rank-i channel based prediction with conventional CSI compression may be as follows:

At 1901, determining, by the UE (101) in the wireless network (204), a channel state information (CSI) (H); determining, by the UE (101), the UE side precoder vector (u) and the network apparatus side precoder vector (v) based on the CSI (H); determining, by the UE (101), candidate precoder (p) based on the UE side precoder vector (u) and the network apparatus side precoder vector (v).

At 1902, encoding, by the UE (101), the candidate precoder into bit stream using the conventional CSI encoding model; Standard NR techniques using Rel-15/16/17 codebooks of type-I or type-II are applicable.

At 1903, transmitting, by the UE (101), the encoded bit stream to the network apparatus (102) in the wireless network (204) through the CSI reporting air interface.

At 1904, receiving, by the network apparatus (102), the encoded bit stream and decodes the precoders \hat{p} using the conventional CSI decoding model; reconstructing, by the network apparatus (102), rank-i channels for each reported rank information using the candidate precoder (p).

At 1905, determining, by the network apparatus (102), predicted CSI (Hₚⁱ) for each channel rank indicator based on reconstructed rank-i channel using ML based CSI prediction.

At 1906, determining, by the network apparatus (102), predicted precoder information from the predicted rank i channel CSI (Hₚⁱ),

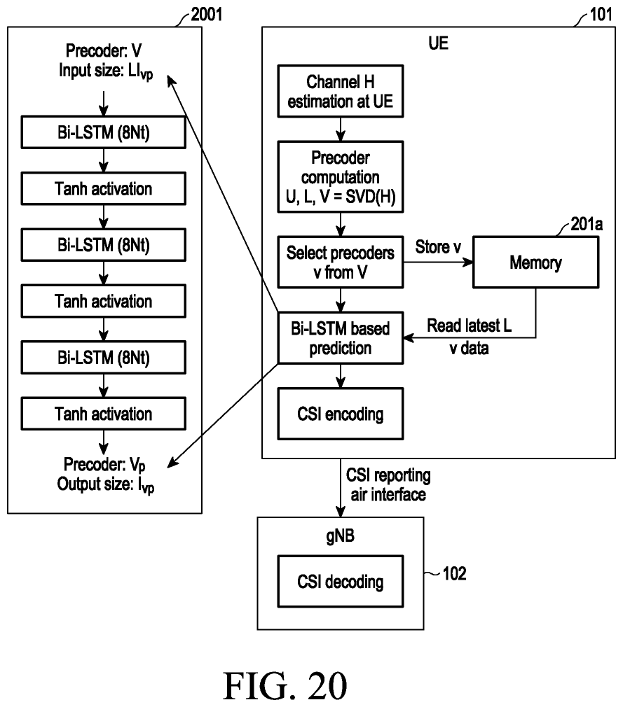

FIG. 20 is a block diagram illustrating an example of UE side prediction in precoder domain, according to various embodiments.

FIG. 20, considering the disclosed method, shows the example of prediction in precoder domain using a Bi-LSTM based implementation. Alternative implementations of the neural network include designs based on dense, CNN, LSTM network types. FIG. 20 includes, the UE (101), the network apparatus (102), a memory (201a), and a Bi-LSTM network (2001).

The UE (101) performs channel estimation and computes the network apparatus (102) side precoder (v). The copy of the precoder is stored to the memory (201a), also latest L precoder measurements are read from the memory (201a). The latest L precoder measurements are fed into three layered Bi-LSTM network (2001) shown in FIG. 20. The Bi-LSTM network (2001) is pre-trained to perform prediction operation. Using the most recent L measurements, Bi-LSTM network (2001) performs prediction at time step t to compute the precoder (vp) corresponding to future time t+T. The precoder (vp) is then encoded and reported to the network apparatus (102), encoding methods include ML or non-ML based, or legacy NR methods. After reception, the network apparatus (102) reconstructs the decoder using ML based decoder and uses it for SU-MIMO or MU-MIMO operation.

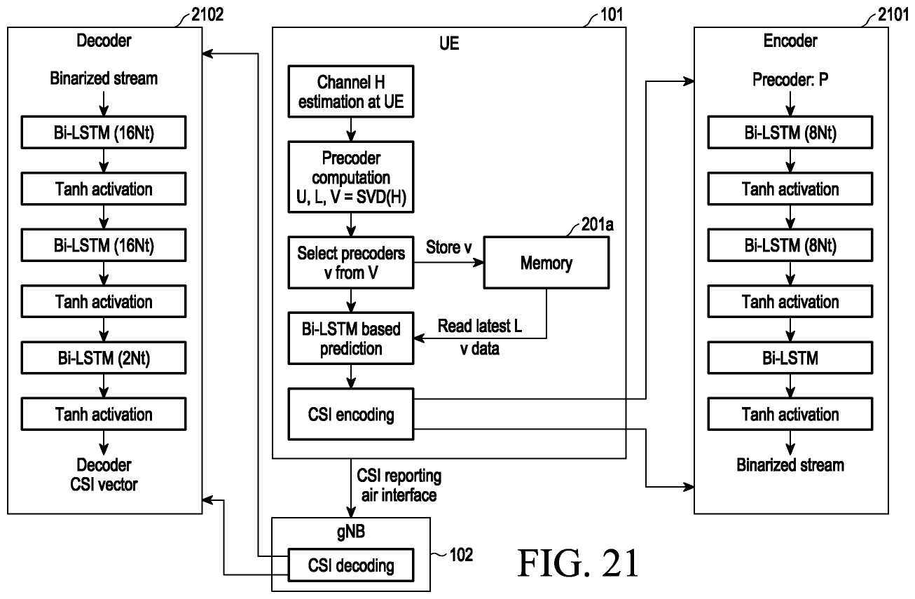

FIG. 21 is a block diagram illustrating an example of UE side prediction with ML based CSI compression, according to various embodiments.

FIG. 21, considering the disclosed method, shows the example of prediction in precoder domain using a Bi-LSTM network based implementation. FIG. 21 includes the UE (101), the network apparatus (102), an encoder (2101), and a decoder (2102), and the memory (201a).

The UE (101) performs channel estimation and computes the network apparatus (102) side precoder (v). The UE (101) performs ML based prediction to obtain predicted precoder (vp). The precoder (vp) is encoded using ML based CSI compression method as shown in FIG. 21. After reception, the network apparatus (102) reconstructs the decoder (2102) using ML based decoder and uses it for SU-MIMO or MU-MIMO operation.

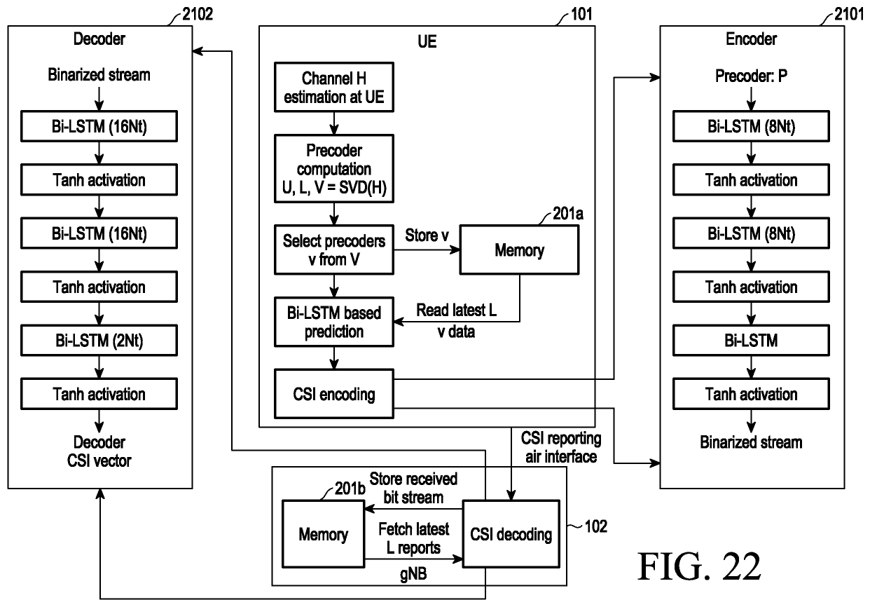

FIG. 22 is a block diagram illustrating an example of UE side prediction with ML based CSI compression, according to various embodiments.

FIG. 22, considering the disclosed method, illustrates the Bi-LSTM network for encoding and decoding at the UE and the network apparatus respective. FIG. 22 includes the UE (101), the network apparatus (102), the encoder (2101), and the decoder (2102), and the memory (201a).

The UE (101) performs channel estimation and computes the network apparatus (102) side precoder (v). The UE (101) performs ML based prediction to obtain predicted precoder (vp). The precoder (vp) is then encoded using ML based CSI compression method. After reception, the network apparatus (102) reconstructs the decoder (2102) using ML based decoder and uses it for SU-MIMO or MU-MIMO operation.

Further, the method shows the Bi-LSTM network (2001) for encoding at the UE (101). The UE (101) performs channel estimation and computes the network apparatus (102) side precoder (v) and performs prediction. The predicted precoder (vp) is then encoded using ML based CSI compression method. After reception, the network apparatus (102) reconstructs the decoder using ML based precoder and uses it for SU-MIMO or MU-MIMO operation. The decoder (2102) at the network apparatus (102) exploits time domain correlation while decoding. This is done by fetching latest L measurements received from the UE (101) and feeding the fetched L measurements to the ML decoder while decoding.

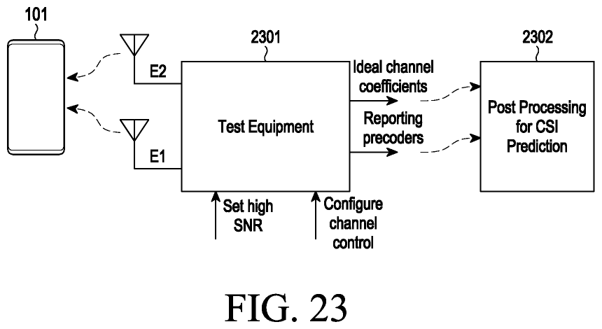

FIG. 23 is a diagram illustrating example test equipment to detect the presence of CSI prediction during reporting, according to various embodiments.

FIG. 23 includes the UE (101), a test equipment (e.g., including various circuitry) (TE) (2301), a post-processing module (e.g., including various circuitry) (2302). The TE (2301) operates a high SNR region. The ideal channel coefficients used during the testing are configured or known. Reporting periodicity for precoders is set to T transmit time intervals.

During the test, the CSI reporting is configured to the UE (101) and TE (2301) collects the precoders reported by the UE (101). This, along with the ideal channel coefficients are extracted as data dumps from the TE (2301) at the end of the testing. The post-processing module (2302) uses the ideal channel coefficients and the ideal precoders at each of the transmit time interval is computed. This is followed by reconstruction of the precoder based on the compression and decompression used.

Now, correlation Cᵢ of the received precoder is computed with ideal precoders in the interval i=1, 2, . . . , T

If the UE (101) is using prediction corresponding to an offset in the interval, T/2 for example, correlation C_{t/2} may show up as the maximum, thereby confirming the prediction capability.

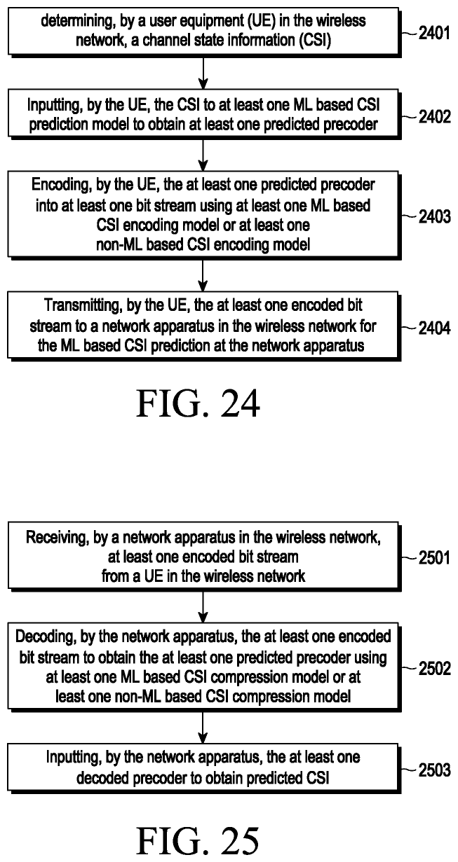

FIG. 24 is a flowchart illustrating an example method for Machine Learning (ML) based channel state information (CSI) prediction in a wireless network, according to various embodiments.

FIG. 24, considering the disclosed method, illustrates the UE for Machine Learning (ML) based channel state information (CSI) prediction in a wireless network, may be as follows:

At 2401, determining, by the user equipment (UE) in the wireless network, a channel state information (CSI).

At 2402, inputting, by the UE, the CSI to the ML based CSI prediction model to obtain predicted precoder.

At 2403, encoding, by the UE, the predicted precoder into the bit stream using the ML based CSI encoding model or the non-ML based CSI encoding model.

At 2404, transmitting, by the UE, the encoded bit stream to the network apparatus in the wireless network for the ML based CSI prediction at the network apparatus.

FIG. 25 is a flowchart illustrating an example method for Machine Learning (ML) based channel state information (CSI) prediction in a wireless network, according to various embodiments.

FIG. 25, considering the disclosed method, illustrates the network apparatus for Machine Learning (ML) based channel state information (CSI) prediction in a wireless network, may be as follows:

At 2501, receiving, by the network apparatus in the wireless network, the encoded bit stream from the UE in the wireless network.

At 2502, decoding, by the network apparatus, the encoded bit stream to obtain the predicted precoder using the ML based CSI compression model or the non-ML based CSI compression model.

At 2503, inputting, by the network apparatus, the decoded precoder to the ML based CSI compression model to obtain predicted CSI.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A method for channel state information (CSI) prediction by a user equipment (UE) in a wireless network, the method comprising:
determining a channel state information (CSI);
inputting the determined CSI to at least one machine learning (ML) based CSI prediction model to obtain at least one predicted precoder;
encoding the at least one predicted precoder into at least one bit stream using at least one ML based CSI encoding model or at least one non-ML based CSI encoding model; and
transmitting the at least one encoded bit stream to a network apparatus in the wireless network for the CSI prediction at the network apparatus.

2. The method of claim 1, wherein inputting the determined CSI to at least one ML based CSI prediction model to obtain at least one predicted precoder comprises:
determining at least one of a UE side precoder vector and a network apparatus side precoder vector based on the CSI; and
inputting the UE side precoder vector and the network apparatus side precoder vector to the ML based CSI prediction model to obtain the at least one predicted precoder.

3. The method of claim 1, wherein inputting the determined CSI to at least one ML based CSI prediction model to obtain at least one predicted precoder comprises:
inputting the CSI to the ML based CSI prediction model to obtain a predicted CSI; and
determining at least one of a UE side precoder vector and a network apparatus side precoder vector based on the predicted CSI.

4. The method of claim 1, wherein inputting the determined CSI to at least one ML based CSI prediction model to obtain at least one predicted precoder comprises:
determining at least one of a UE side precoder vector and a network apparatus side precoder vector based on the CSI;
determining at least one candidate CSI to be reported for each channel rank indicator of a plurality of channel rank indicators based on the UE side precoder vector and the network apparatus side precoder vector;
determining at least one predicted rank CSI based on the at least one candidate CSI to be reported for each channel rank indicator of the plurality of channel rank indicators using the at least one ML based CSI prediction model; and
determining the at least one predicted precoder for each channel rank indicator of the plurality of channel rank indicators based on the at least one predicted CSI.

5. The method of claim 1, wherein the at least one non-ML based CSI encoding comprises at least one of quantization of the at least one predicted precoder, a New Radio (NR) precoding Type I codebook, and a NR precoding Type II codebook and compressive sensing.

6. The method of claim 1, wherein the at least one encoded bit stream is transmitted to the network apparatus using a specified CSI reporting air interface.

7. The method of claim 1, wherein the method further comprises:
selecting an artificial intelligence model from a set of pre-trained encoders and decoders stored in a memory of the UE based on an AI model indicator received from the network apparatus for the ML based CSI encoding.

8. A method for channel state information (CSI) prediction by a network apparatus in a wireless network, comprising:
receiving at least one encoded bit stream from a UE in the wireless network;
decoding the at least one encoded bit stream to obtain at least one predicted precoder using at least one machine learning (ML) based CSI compression model or at least one non-ML based CSI compression model; and
inputting the at least one predicted precoder to the ML based CSI prediction model to obtain predicted CSI.

9. The method of claim 8, wherein inputting the at least one decoded precoder to obtain the predicted CSI comprises:
determining at least one of a UE side precoder vector and a network apparatus side precoder vector based on the at least one predicted precoder; and
inputting at least one of the UE side precoder vector and the network apparatus side precoder vector to the ML based CSI prediction model to obtain the predicted CSI.

10. The method of claim 8, wherein inputting the at least one decoded precoder to obtain the predicted CSI comprises:
determining at least one of a UE side precoder vector and a network apparatus side precoder vector based on the at least one predicted precoder;
determining at least one candidate CSI for each channel rank indicator of a plurality of channel rank indicators based on the at least one of the UE side precoder vector and the network apparatus side precoder vector; and
inputting at least one candidate CSI to the ML based CSI prediction model to obtain the predicted CSI.

11. The method of claim 8, wherein the at least one non-ML based CSI encoding model comprises at least one of quantization of the at least one predicted precoder, a New Radio (NR) precoding Type I codebook, and a NR precoding Type II codebook and compressive sensing.

12. The method of claim 8, wherein the at least one encoded bit stream is received from the UE using a specified CSI reporting air interface.

13. The method of claim 8, wherein the method further comprises:
selecting an artificial intelligence model from a memory of the network apparatus based on an AI model indicator for the ML based CSI encoding.

14. The method of claim 9, wherein the method further comprises:
selecting at least one AI model from a set of trained encoders and decoders stored in the memory of the network apparatus; and
transferring at least one AI encoder model to the UE and indicating to select at least one AI model based on the AI model indicator.

15. A user equipment (UE) for machine learning (ML) based channel state information (CSI) prediction in a wireless network, comprising:
a memory; and
at least one processor coupled to the memory, wherein the at least one processor is configured to:
determine a CSI,
input the determined CSI to at least one machine learning (ML) based CSI prediction model to obtain at least one predicted precoder,
encode the at least one predicted precoder into at least one bit stream using at least one ML based CSI encoding model or at least one non-ML based CSI encoding model, and
transmit the at least one encoded bit stream to a network apparatus in the wireless network for the ML based CSI prediction at the network apparatus.

16. The UE of claim 15, wherein for inputting the determined CSI to at least one ML based CSI prediction model to obtain at least one predicted precoder, the at least one processor is configured to:
determine at least one of a UE side precoder vector and a network apparatus side precoder vector based on the CSI; and
input the UE side precoder vector and the network apparatus side precoder vector to the ML based CSI prediction model to obtain the at least one predicted precoder.

17. The UE of claim 15, wherein for inputting the determined CSI to at least one ML based CSI prediction model to obtain at least one predicted precoder, the at least one processor is configured to:
input the CSI to the ML based CSI prediction model to obtain a predicted CSI; and
determine at least one of a UE side precoder vector and a network apparatus side precoder vector based on the predicted CSI.

18. The UE of claim 15, wherein for inputting the determined CSI to at least one ML based CSI prediction model to obtain at least one predicted precoder, the at least one processor is configured to:
determine at least one of a UE side precoder vector and a network apparatus side precoder vector based on the CSI;
determine at least one candidate CSI to be reported for each channel rank indicator of a plurality of channel rank indicators based on the UE side precoder vector and the network apparatus side precoder vector;
determine at least one predicted rank CSI based on the at least one candidate CSI to be reported for each channel rank indicator of the plurality of channel rank indicators using the at least one ML based CSI prediction model; and
determine the at least one predicted precoder for each channel rank indicator of the plurality of channel rank indicators based on the at least one predicted CSI.

19. The UE of claim 15, wherein the at least one non-ML based CSI encoding comprises at least one of quantization of the at least one predicted precoder, a New Radio (NR) precoding Type I codebook, and a NR precoding Type II codebook and compressive sensing.

20. The UE of claim 15, wherein the at least one encoded bit stream is transmitted to the network apparatus using a specified CSI reporting air interface.
